(19) United States
(12) Patent Application Publication
(10) Pub. No.: US 2024/0169007 A1
(43) Pub. Date: May 23, 2024

(54) SYSTEMS, METHODS, AND STORAGE MEDIA FOR SEARCHING ONE OR MORE DATA SOURCES

(71) Applicant: Spinnaker Support, LLC, Greenwood Village, CO (US)

(72) Inventors: Taylor Gloege, Centennial, CO (US); Anthony Cefola, Cary, NC (US)

(21) Appl. No.: 17/990,650

(22) Filed: Nov. 18, 2022

(51) Int. Cl. G06F 16/9538; G06F 16/951

(52) U.S. Cl. CPC G06F 16/9538; G06F 16/951

(57) ABSTRACT

Systems, methods, and storage media for searching one or more data sources are disclosed. Exemplary implementations may: identify one or more search terms; identify a context associated with the one or more search terms; determine whether additional terms are associated with the one more search terms and the context associated with the one or more search terms; access one more databases; access information related to one or more web sites; and provide a ranked list of items obtained from at least one of the one or more databases and the one or more web sites.

### FIELD OF THE DISCLOSURE

The present disclosure relates to systems, methods, and storage media for searching one or more data sources.

### BACKGROUND

Numerous businesses/enterprises utilize third-party enterprise software provided by software vendors. For example, numerous businesses use ORACLE or SAP on-premises enterprise or infrastructure product sets for a wide range of business applications. In some circumstances, software vendors provide technical support to the end-users of their enterprise software applications. Besides being expensive, the technical support provided by software vendors is often limited in nature. As such, end-users often rely on third-party software support for navigating the intricacies of enterprise software applications. Currently used third-party software support solutions suffer some deficiencies, including, but not limited to, high resolution times.

The description provided in the background section should not be assumed to be prior art merely because it is mentioned in or associated with the background section. The background section may include information that describes one or more aspects of the subject technology.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

One aspect of the present disclosure relates to a system configured for searching one or more data sources. The system may include one or more hardware processors configured by machine-readable instructions. The processor(s) may be configured to identify one or more search terms. The processor(s) may be configured to identify a context associated with the one or more search terms. The processor(s) may be configured to determine whether additional terms are associated with the one more search terms and the context associated with the one or more search terms. The processor(s) may be configured to access one more databases. The processor(s) may be configured to access information related to one or more web sites. The processor(s) may be configured to provide a ranked list of items obtained from at least one of the one or more databases and the one or more web sites. In some implementations, the ranked list of items includes items related to the one or more search terms.

Another aspect of the present disclosure relates to a method for searching one or more data sources. The method may include identifying one or more search terms. The method may include identifying a context associated with the one or more search terms. The method may include determining whether additional terms are associated with the one more search terms and the context associated with the one or more search terms. The method may include accessing one more databases. The method may include accessing information related to one or more web sites. The method may include providing a ranked list of items obtained from at least one of the one or more databases and the one or more web sites. In some implementations, the ranked list of items includes items related to the one or more search terms.

Yet another aspect of the present disclosure relates to a non-transient computer-readable storage medium having instructions embodied thereon, the instructions being executable by one or more processors to perform a method for searching one or more data sources. The method may include identifying one or more search terms. The method may include identifying a context associated with the one or more search terms. The method may include determining whether additional terms are associated with the one more search terms and the context associated with the one or more search terms. The method may include accessing one more databases. The method may include accessing information related to one or more web sites. The method may include providing a ranked list of items obtained from at least one of the one or more databases and the one or more web sites. In some implementations, the ranked list of items includes items related to the one or more search terms.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured for searching one or more data sources, according to various aspects of the disclosure.

FIG. 2 illustrates a method for searching one or more data sources, according to various aspects of the disclosure.

FIG. 3 illustrates a swim diagram directed to a method for searching for one or more data sources, according to various aspects of the disclosure.

FIG. 4 illustrates an example of a system configured for searching one or more data sources, according to various aspects of the disclosure.

FIG. 5 illustrates an example of a process flow directed to a method for searching one or more data sources, according to various aspects of the disclosure.

FIG. 6 illustrates a diagrammatic representation of a computer system configured for searching one or more data sources, according to various aspects of the disclosure.

### DETAILED DESCRIPTION

In the following detailed description, references are made to the accompanying drawings that form a part hereof, and in which are shown by way of illustrations or specific examples. These aspects may be combined, other aspects may be utilized, and structural changes may be made without departing from the present disclosure. Example aspects may be practiced as methods, systems, or devices. Accordingly, example aspects may take the form of a hardware implementation, a software implementation, or an implementation combining software and hardware aspects. The following detailed description is therefore not to be taken in a limiting sense, and the scope of the present disclosure is defined by the appended claims and their equivalents.

The words “for example” is used herein to mean “serving as an example, instant, or illustration.” Any embodiment described herein as “for example” or any related term is not necessarily to be construed as preferred or advantageous over other embodiments. Additionally, a reference to a “device” is not meant to be limiting to a single such device. It is contemplated that numerous devices may comprise a single “device” as described herein.

The embodiments described below are not intended to limit the disclosure to the precise form disclosed, nor are they intended to be exhaustive. Rather, the embodiment is presented to provide a description so that others skilled in the art may utilize its teachings. Technology continues to develop, and elements of the described and disclosed embodiments may be replaced by improved and enhanced items, however the teaching of the present disclosure inherently discloses elements used in embodiments incorporating technology available at the time of this disclosure.

The detailed descriptions which follow are presented in part in terms of algorithms and symbolic representations of operations on data within a computer memory wherein such data often represents numerical quantities, alphanumeric characters or character strings, logical states, data structures, or the like. A computer generally includes one or more processing mechanisms for executing instructions, and memory for storing instructions and data.

When a general-purpose computer has a series of machine-specific encoded instructions stored in its memory, the computer executing such encoded instructions may become a specific type of machine, namely a computer particularly configured to perform the operations embodied by the series of instructions. Some of the instructions may be adapted to produce signals that control operation of other machines and thus may operate through those control signals to transform materials or influence operations far removed from the computer itself. These descriptions and representations are the means used by those skilled in the data processing arts to convey the substance of their work most effectively to others skilled in the art.

The term algorithm as used herein, and generally in the art, refers to a self-consistent sequence of ordered steps that culminate in a desired result. These steps are those requiring manipulations of physical quantities. Usually, though not necessarily, these quantities take the form of electrical or magnetic pulses or signals capable of being stored, transferred, transformed, combined, compared, and otherwise manipulated. It is often convenient for reasons of abstraction or common usage to refer to these signals as bits, values, symbols, characters, display data, terms, numbers, or the like, as signifiers of the physical items or manifestations of such signals. It should be borne in mind, however, that all of these and similar terms are to be associated with the appropriate physical quantities and are merely used here as convenient labels applied to these quantities.

Some algorithms may use data structures for both inputting information and producing the desired result. Data structures facilitate data management by data processing systems and are not accessible except through sophisticated software systems. Data structures are not the information content of a memory, rather they represent specific electronic structural elements which impart or manifest a physical organization on the information stored in memory. More than mere abstraction, the data structures are specific electrical or magnetic structural elements in memory which simultaneously represent complex data accurately, often data modeling physical characteristics of related items, and provide increased efficiency in computer operation. By changing the organization and operation of data structures and the algorithms for manipulating data in such structures, the fundamental operation of the computing system may be changed and improved.

In the descriptions herein, operations and manipulations are often described in terms, such as comparing, sorting, selecting, or adding, which are commonly associated with mental operations performed by a human operator. It should be understood that these terms are employed to provide a clear description of an embodiment of the present disclosure, and no such human operator is necessary, nor desirable in most cases.

This requirement for machine implementation for the practical application of the algorithms is understood by those persons of skill in this art as not a duplication of human thought, rather as significantly more than such human capability. Useful machines for performing the operations of one or more embodiments of the present invention include general purpose digital computers or other similar devices. In all cases the distinction between the method operations in operating a computer and the method of computation itself should be recognized. One or more embodiments of the present disclosure relate to methods and apparatus for operating a computer in processing electrical or other (e.g., mechanical, chemical) physical signals to generate other desired physical manifestations or signals. The computer operates on software or instruction modules, which are collections of signals stored on a media that represents a series of machine instructions that enable the computer processor to perform the machine instructions that implement the algorithmic steps. Such machine instructions may be the actual computer code the processor interprets to implement the instructions, or alternatively may be a higher-level coding of the instructions that is interpreted to obtain the actual computer code. The software or instruction module may also include a hardware component, wherein some aspects of the algorithm are performed by the circuitry itself rather as a result of an instruction.

Some embodiments of the present disclosure rely on an apparatus for performing disclosed operations. This apparatus may be specifically constructed for the required purposes, or it may comprise a general purpose or configurable device, such as a computer selectively activated or reconfigured by a program comprising instructions stored to be accessible by the computer. The algorithms presented herein are not inherently related to any particular computer or other apparatus unless explicitly indicated as requiring particular hardware. In some cases, the computer programs may communicate or interact with other programs or equipment through signals configured to particular protocols which may or may not require specific hardware or programming to accomplish. In particular, various general-purpose machines may be used with programs written in accordance with the teachings herein, or it may prove more convenient to construct more specialized apparatus to perform the required method steps. The required structure for a variety of these machines will be apparent from the description below.

In the following description, several terms which are used frequently have specialized meanings in the present context.

In the description of embodiments herein, frequent use is made of the terms server, client, and client/server architecture. In this context, a server and client are each instantiations of a set of functions and capabilities intended to support distributed computing. These terms are often used to refer to a computer or computing machinery, yet it should be appreciated that the server or client function is provided by machine execution of program instructions, threads, modules, processes, or applications. The client computer and server computer are often, but not necessarily, geographically separated, although the salient aspect is that client and server each perform distinct, but complementary functions to accomplish a task or provide a service. The client and server accomplish this by exchanging data, messages, and often state information using a computer network, or multiple networks. It should be appreciated that in a client/server architecture for distributed computing, there are typically multiple servers and multiple clients, and they do not map to each other and further there may be more servers than clients or more clients than servers. A server is typically designed to interact with multiple clients.

In networks, bi-directional data communication (i.e., traffic) occurs through the transmission of encoded light, electrical, or radio signals over wire, fiber, analog, digital cellular, Wi-Fi, or personal communications service (PCS) media, or through multiple networks and media connected by gateways or routing devices. Signals may be transmitted through a physical medium such as wire or fiber, or via wireless technology using encoded radio waves. Much wireless data communication takes place across cellular systems using second generation technology such as code-division multiple access (CDMA), time division multiple access (TDMA), the Global System for Mobile Communications (GSM), Third Generation (wideband or 3G), Fourth Generation (broadband or 4G), Fifth Generation (5G), personal digital cellular (PDC), or through packet-data technology over analog systems such as cellular digital packet data (CDPD).

In recent years, the rise of customer-focused service delivery has been at the core of Information Technology (IT) services, including technical support for enterprise software applications. In some embodiments, Artificial Intelligence (AI) and Machine Learning (ML) may be deployed to this domain to help decrease the resolution time for service incidents and/or enhance the overall customer experience. Natural language search is an emerging use case of AI that is based on a computer science technique called natural language processing (NLP). This process uses input/training data to run statistical and machine-learning models that infer meaning from grammatical sentences. In accordance with aspects of the disclosure, a search engine based on natural language search can help provide technical support personnel with the information they need to resolve service incidents faster and more efficiently, as compared to the prior art. Additionally, the disclosed search engine (or search system) can aggregate information from disparate data sources, service data associated with prior performed searches, technical documents, case studies, white papers, etc., and provide the relevant results/items as a ranked list of items to a user (e.g., technical support user), which can help for faster and more accurate incident resolution.

In some aspects, AI and ML-based research utilities can help enhance customer experience in the realm of technical support by allowing for added flexibility (e.g., in the search terms input by the user) and consistency in service response across a wide range of technologies (e.g., an AI and ML-based search engine may derive insights from a common set of data). The system (e.g., system 100, system 400) of the present disclosure may assist in one or more of: break/fix services, security and vulnerability management, Global Tax, Regulatory and Compliance (GTRC), general inquiry, and technical support/advisory services for multiple enterprise software system (e.g., ORACLE, SAP, and JD EDWARDS). In some cases, break/fix services include assisting a client (e.g., customer or business) with their enterprise applications due to an issue. For example, break/services may comprise diagnosing and fix an issue (e.g., database crash) to reduce or minimize downtime and disruption to the client.

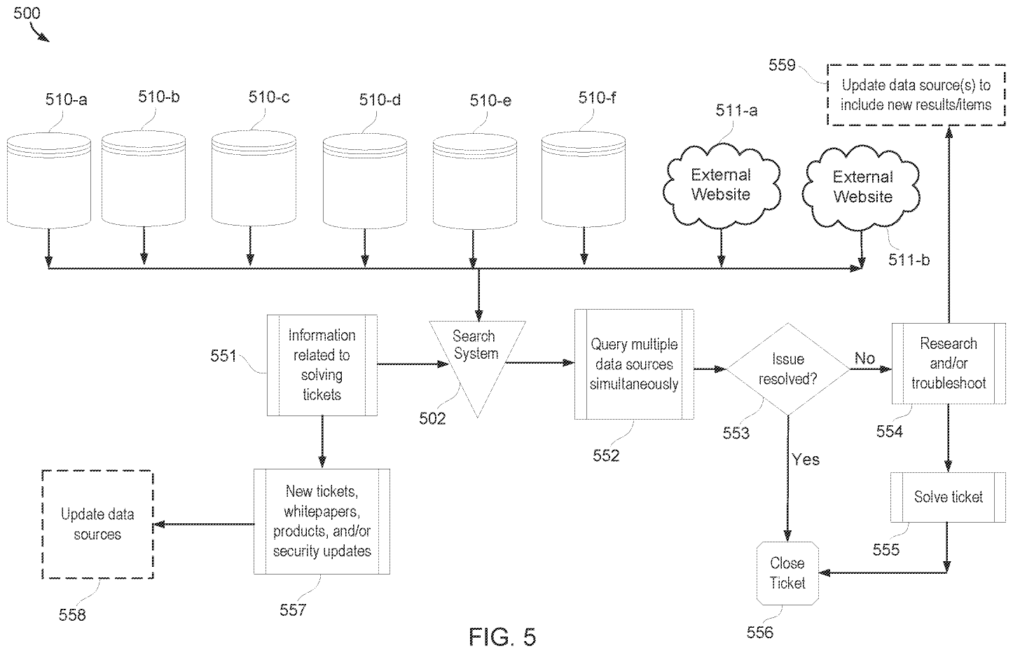

In some cases, the system utilizes multiple data sources and various insights (e.g., from prior resolved service tickets, knowledge articles, technical documents, publicly available information) to help users find an optimal solution to a client support issue. For example, using AI technology via machine learning and/or natural language search, the system of the present disclosure assesses service or support data, including service tickets, case studies, white papers, etc., determines the relevancy of the various results or items to the one or more search terms input by the user, and outputs a list of items that may help the user address the technical support issue raised by the client. Additionally, the system can refine its search and ranking methodology as it performs more searches and receives feedback data (e.g., up/down votes) from the various users of the search system (e.g., shown as search system 502 in FIG. 5).

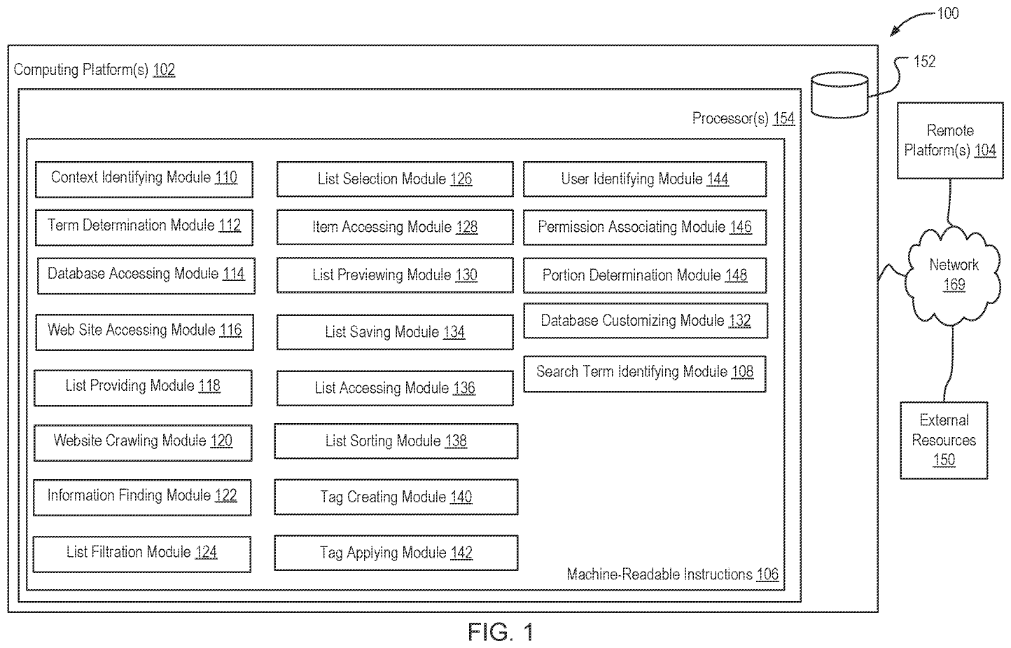

FIG. 1 illustrates a system 100 configured for searching one or more data sources, in accordance with one or more implementations. In some implementations, system 100 may include one or more servers 102. Server(s) 102 (also referred to as computing platforms 102) may be configured to communicate with one or more client computing platforms 104 (or remote platforms 104) according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Server(s) 102 may be configured by machine-readable instructions 106. Machine-readable instructions 106 may include one or more instruction modules. The instruction modules may include computer program modules. The instruction modules may include one or more of search term identifying module 108, context identifying module 110, term determination module 112, database accessing module 114, web site accessing module 116, list providing module 118, website crawling module 120, information finding module 122, list filtration module 124, list selection module 126, item accessing module 128, list previewing module 130, database customizing module 132, list saving module 134, list accessing module 136, list sorting module 138, tag creating module 140, tag applying module 142, user identifying module 144, permission associating module 146, portion determination module 148, and/or other instruction modules.

Search term identifying module 108 may be configured to identify one or more search terms (e.g., database crash, DB crash, database crashed, to name a few).

Context identifying module 110 may be configured to identify a context associated with the one or more search terms. As an example, a context may comprise an error or an issue, an error code, a filetype (e.g., ticket, case study, an Active Directory record, a Smartsheet), a component type (e.g., database, ORACLE database), an error code or message, a project or customer name, project category (e.g., active or inactive client/customer), or any other applicable context.

Term determination module 112 may be configured to determine whether additional terms are associated with the one more search terms and the context associated with the one or more search terms.

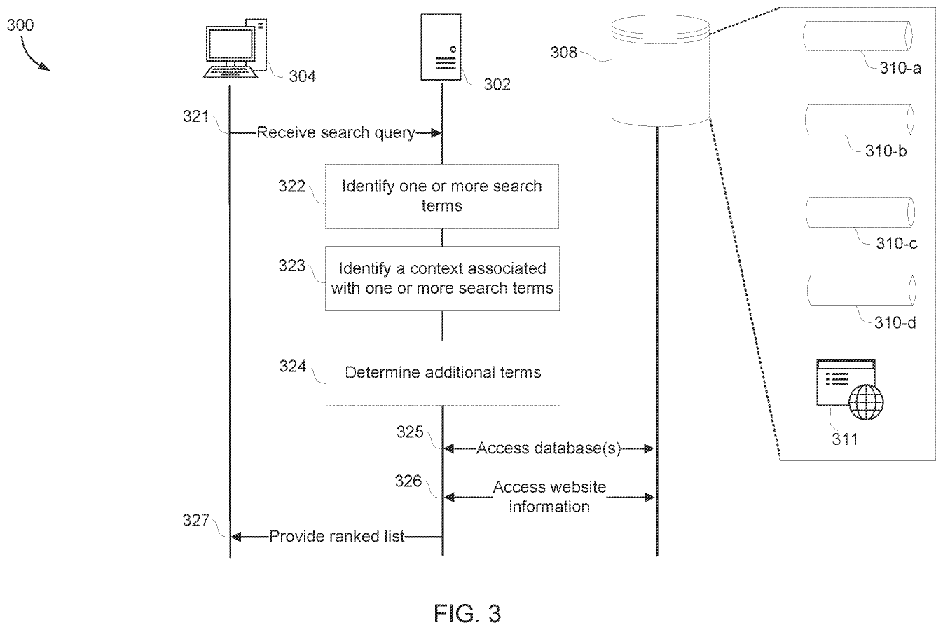

Database accessing module 114 may be configured to access one more databases, further described below in relation to FIGS. 3-5.

Web site accessing module 116 may be configured to access information related to one or more web sites, further described below in relation to FIGS. 3-5.

List providing module 118 may be configured to provide a ranked list of items obtained from at least one of the one or more databases and the one or more web sites. The ranked list of items may include a display of items. By way of non-limiting example, the ranked list of items may be sorted by one or more of items selected from prior performed searches, order of items selected from prior performed searches, one or more or an up vote and a down vote, and type of user. As an example, the order of items selected from prior performed searches may include identifying a first selected item, a second selected item (if any), and a final selected item. In some circumstances, the first selected item may be the same as the final selected item. In some cases, the order of items selected from prior performed searches may include identifying a first selected item as a highly-ranked item and a final selected item as a highest ranked item. The ranked list of items may include items related to the one or more search terms.

Website crawling module 120 may be configured to crawl the one or more websites. In some cases, crawling the website may include using a software application (e.g., a web crawler, or spider) to index the content of the one or more web sites, which allows the one or more websites to appear in the search results provided by the system 100. Crawling the one or more websites may include parsing or adding at least a portion of the words on the one or more websites to an index. That is, the website crawling module 120 is configured to visit pages of the one or more websites and index the content on the one or more pages such that the relevant pages can be retrieved in response to a search query.

Information finding module 122 may be configured to find information related to at least one of the one or more topics and the one or more search terms. In some embodiments, the information finding module 122 (or another module, such as the list providing module 118) may be configured to at least one of index and point to the information related to the at least one of the one or more topics and the one or more search terms.

List filtration module 124 may be configured to filter the ranked list of items using one or more of the metadata associated with the one or more databases and the one or more websites.

In some cases, accessing the one or more databases and accessing information related to the one or more web sites comprises selecting one of the one or more databases and the one or more web sites to access and read data and metadata associated with the one or more databases and the one or more websites. As noted above, the ranked list of items may include a display of items. Additionally, one of the top item and the first item in the display of items may comprise an item most likely to relate to the one or more search terms.

List selection module 126 may be configured to identify an order in which items are selected from a ranked list of items (e.g., from a prior performed search). Additionally, or alternatively, the list selection module 126 (or another module of system 100) is configured to identify an order in which items are listed in a ranked listed of items (e.g., for a current search) based on identifying the order in which items were selected for a prior performed search. As an example, if a ranked list of items for a search contains 5 items: A, B, C, D, E, listed in that order, the first item A is most likely to relate to the one or more search terms and the last item E is least likely to relate to the one or more search terms. In this example, if a user selects item B, followed by item E, followed by item D, the list selection module 126 may identify that item D (last selected item) is the highest ranked item, followed by items E and B. In such cases, the list selection module 126 may update the likelihood ranking of the items such that item D is most likely to relate to the one or more search terms and items A and C are least likely to relate to the one or more search terms. After updating the ranking, the system 100 may present item D as the top or first item in a ranked list of items for a similar or identical search performed in the future. That is, the system 100 updates the ranking methodology used for generating the ranked list of items based on identifying at least an order in which items are selected by users.

In some other cases, list selection module 126 is configured to select one of the ranked listed of items. Upon selecting one of the ranked list of items (i.e., by the list selection module 126), item accessing module 128 may be configured to access the selected item.

List previewing module 130 may be configured to preview one of the ranked list of items. Upon previewing one of the ranked list of items, at least a portion of the previewed item may be displayed by the list previewing module 130 (or another instruction module of system 100).

In some embodiments, a taxonomy (i.e., classification) for the one or more search terms may be implemented prior to identifying the one or more search terms. The taxonomy may comprise associating one or more words with at least one of the one or more search terms.

By way of non-limiting example, the one or more databases (e.g., shown as databases 310-a, 310-b, 310-c, 310-d) described herein may include a ticketing system database involving one or more topics, a database including client information, an internal resource database, a general database. In some embodiments, accessing information related to one or more web sites includes (1) crawling the website, (2) finding information related to the one or more topics, and (3) at least one of indexing and pointing to the information related to the one or more topics.

The ticketing system database (e.g., database 310-a in FIG. 3) may include a first Jira cloud database and first information related to a customer. The database (e.g., database 310-b in FIG. 3) including client information may include a second Jira cloud database and second information related to a customer. The second information related to a customer may be different from the first information related to a customer. By way of non-limiting example, the internal resource database (e.g., database 310-c in FIG. 3) may include information related to individuals associated with an entity (e.g., technical support personnel or individuals associated with a third-party software support organization), availability of the individuals, and one or more subject matters associated with the individuals (e.g., The general database (e.g., database 310-d) may include descriptions of at least some of the one or more topics. By way of non-limiting example, at least some of the descriptions may include guides and/or books, customer or client information, process information, and employee information.

The one or more search terms may include natural language search terms (e.g., database crash, financial close issue). Identifying a context associated with the one or more search terms may include for at least one of the one or more search terms applying the other of the one or more search terms to identify a meaning of the at least one of the one or more search terms. As an example, the system 100 may be configured to retrieve one or more tickets (e.g., Jira tickets) associated with or comprising any of the following terms: database crash, DB crash, DB crashed, database crashed, SQL crash, ORACLE database crash, etc. The system 100 may also retrieve items or results that use the term “crash”, or “crashed” with reference to a database, even though the two terms are not adjacent to each other. In yet other cases, the system 100 retrieves items that comprise the word “database”, or an alternative (e.g., DB, data base, SQL, DBA), and a term that is generally used to refer to a problem or an issue (e.g., abort, error, connectivity issue, failure, malfunction, etc.). For example, in response to the search term “database crash”, the system 100 may retrieve tickets having the terms “database malfunction”, “intermittent connectivity to the database”, “ORACLE Instance Crashed”, and/or “failure of database”. Generally, the search terms may be related to common issues experienced by users of a given enterprise software system, such as, but not limited to, JD EDWARDS, ORACLE, and SAP. In some instances, a user (e.g., skilled technical support engineer) may enter a search query (or one or more search terms) based on the issue raised by the customer. For example, the customer may submit a ticket indicating a problem or a question (e.g., total value on invoice is not being printed; issues with synchronizing or updating configurations) associated with an enterprise software system. In some aspects, the ticket submitted by the customer includes details on the “symptom”, while the system 100 helps the technical support user identify the root cause, as well as previous approaches to addressing said root cause given the same or similar symptom, further described below.

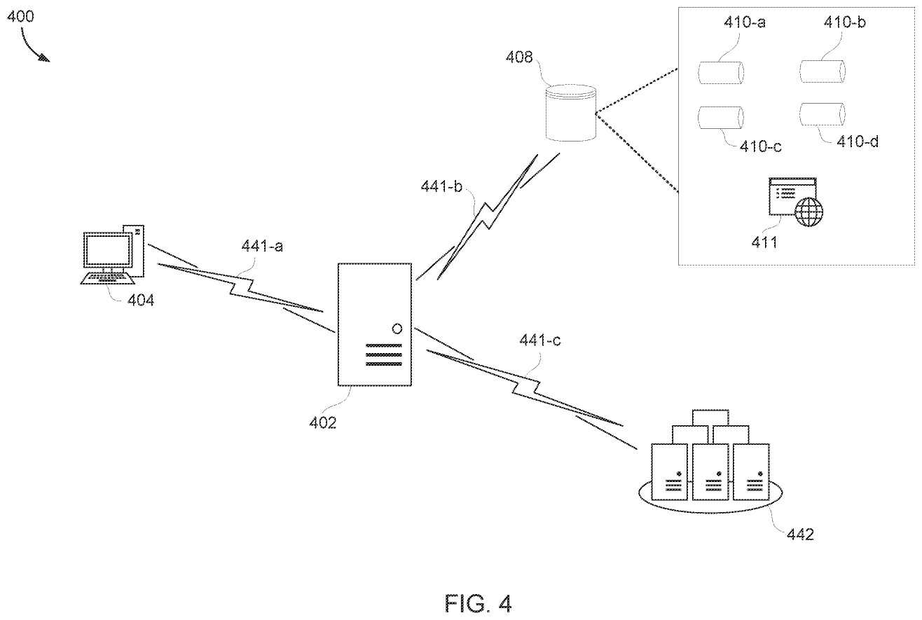

The first information related to a customer may include one or more of a problem and a question associated with one or more of a system associated with a customer and a third-party system (e.g., shown as third-party system 442 in FIG. 4). By way of non-limiting example, the one or more topics may include an enterprise software system, tax information, and one of governmental compliance information and regulatory information. Some non-limiting examples of search queries or search terms may include: database crash; IO Error-Connection reset by peer-socket write error; not printing total value invoice; delete frozen tax distributions; Exception, java.lang.IllegalArgumentException: String is zero length.>, while trying to Generate with stack trace; AWS Migration, etc. Thus, as seen, the system 100 is configured to receive search queries with varying levels of complexity (e.g., in vocabulary or technical jargon) and/or specificity, to name two non-limiting examples. Further, the system 100 is configured to parse the search query (or search terms) and perform natural language processing (e.g., based on analyzing a proximity or separation of words) to identify a context of the search terms input by the user, the problem or question raised by the client/customer, or a combination thereof. As an example, a customer may submit a ticket because a particular application is crashing upon startup. In this instance, the user (e.g., skilled technical support engineer) may use the system 100 to identify the “root cause” that is causing that particular application to crash upon startup. For example, the system 100 may help the user identify that the root cause is related to a “consoles startup” issue, based on identifying similar or substantially similar incidents that have occurred in the past. As described herein, the system 100 is configured to collect and index data related to technical support issues (e.g., previously resolved tickets), supporting documents for enterprise software systems, etc., and retrieve and present said data to optimize the technical/customer support process. In some aspects, the system 100 helps alleviate the need for each user (e.g., technical support engineer/representative) to solve a customer problem/issue from scratch, by allowing the user to search for similar problems encountered in the past and access information related to resolving said problems.

In some implementations, using the other of the one or more search terms to identify a meaning of the at least one of the one or more search terms may include accessing a data store. In some implementations, using the other of the one or more search terms to identify a meaning of the at least one of the one or more search terms may include finding in the data store one or more prior definitions of the at least one of the one or more search terms when used with the other of the one or more search terms and any additional terms associated with the other of the one or more search terms. By way of non-limiting example, using the other of the one or more search terms to identify a meaning of the at least one of the one or more search terms may include using the other of the one or more search terms, the one or more prior definitions, and the at least one of the one or more search terms to obtain a definition of the at least one of the one or more search terms. For instance, the system 100 may utilize one or more terms in a search query to provide meaning (or context) to one or more other terms in the search query. As an example, for the search query “SQL database crash”, the system 100 may utilize the terms “crash” and “SQL” to provide context/meaning to the term “database”. In some cases, the system 100 analyses the proximity or separation between words (i.e., using natural language processing or NLP techniques) to determine whether certain words in a search query are associated with, or related to each other. Additionally, the system 100 utilizes NLP to determine to what degree certain words or terms are related to each other. In the above example, the terms “SQL” and “database” may be identified as being related to each other to a high degree, since the system 100 is aware that SQL is a standardized programming language used to manage relational databases. On the other cases, the term “crash” may not always be related with the term “database”, since other software programs (e.g., MICROSOFT WORD, email clients, such as OUTLOOK, etc.) are also susceptible to crashing. In another example, the system 100 may receive the search query “SQL database crash during update”. Here, the system 100 may identify that the terms “modify”, “new data”, “revise”, “change”, “alter”, “amend”, “malfunction”, and “error” were also used in relation to SQL database crashes. In such cases, the system 100 determines that the SQL database crash is occurring whenever the customer/client is attempting to update data in the SQL database and provides one or more results or solutions that helped fix the issue (e.g., go to settings, change configuration A to B, unselect option C, restart software). Additionally, or alternatively, the system 100 speculates that the SQL database crash is occurring due to a recent software update (e.g., new software version) based on accessing information related to the same or similar issues experienced by other customers and provides the user (or technical support engineer) information on reverting back the software updates.

In some implementations, accessing one more databases and accessing information related to one or more web sites may include selecting one of the one more databases and the one or more web sites to access and read data and metadata associated with the one or more databases and the one or more web sites.

In some embodiments, one of the top item and the first item in the display of items may include an item most likely to relate to the one or more search terms. Additionally, one of the bottom item and the last item in the display may include an item least likely to relate to the one or more search terms. By way of non-limiting example, the metadata may include one or more of a date associated with each of the ranked list of items, an assignee, a component (e.g., a ticketing system component, such as, ORACLE database, database, ORACLE database-Americas, ORACLE Goldengate, to name a few) assigned in an issue tracking platform (e.g., a cloud based ticketing system, such as Jira), an error code (e.g., ORA-00600, ORA-07445, ORA-1092, OA-017503), an error message (e.g., internal error code, arguments; exception encountered; additional information; unable to lock row cache entry; unable to get lock on queue, to name a few non-limiting examples), a ticket priority designation (e.g., critical, high, medium, or low priority), a project/customer name, a ticket status (e.g., open or closed), a date associated with any item updates, filetype (e.g., Spreadsheet, PDF, HTML document, etc.), type of items (e.g., ticket, case study, whitepaper, Smartsheet, Active Directory record, customer profile), product category (e.g., ORACLE, JDE, SAP, etc.), and a manually-added item. By way of non-limiting example, the assignee may include one of an individual, an entity, and a group associated with each of the ranked list of items.

Database customizing module 132 may be configured to customize the one more databases and the information related to one or more web sites to enable displaying the ranked list of items and the previewing one of the ranked list of items.

List saving module 134 may be configured to save the ranked list of items.

List accessing module 136 may be configured to access the saved ranked list of items.

List sorting module 138 may be configured to sort the ranked list of items by one sorting list category including relevance, date, size, age group, author, category, city, company, content type, country, department, extension, job title, language, path, postal code, presentation format, region, status, and tag. By way of non-limiting example, the one or more websites (e.g., shown as website 311 in FIG. 3) may include one or more of a web and application management website, a network monitoring website, a database software website, and an enterprise software website.

Tag creating module 140 may be configured to create a sub-search tag. The sub search tag may include a tag associated with one or more of a sorting list category and a selected metadata item.

Tag applying module 142 may be configured to apply the sub-search tag to one or more new search terms.

User identifying module 144 may be configured to identify a user providing the one or more search terms.

Permission associating module 146 may be configured to associate a plurality of permissions with the user. By way of non-limiting example, the plurality of permissions may include issue tracking platform permissions, collaborative document management and storage system permissions, and project management software permissions.

Portion determination module 148 may be configured to determine one or more portions of the one more databases and the one or more web sites accessible by the user with the plurality of permissions.

In some implementations, server(s) 102, client computing platform(s) 104, and/or external resources 150 may be operatively linked via one or more electronic communication links. For example, such electronic communication links may be established, at least in part, via a network 169 such as the Internet and/or other networks. It will be appreciated that this is not intended to be limiting, and that the scope of this disclosure includes implementations in which server(s) 102, client computing platform(s) 104, and/or external resources 150 may be operatively linked via some other communication media.

A given client computing platform 104 may include one or more processors configured to execute computer program modules. The computer program modules may be configured to enable an expert or user associated with the given client computing platform 104 to interface with system 100 and/or external resources 150, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 150 may include sources of information outside of system 100, external entities participating with system 100, and/or other resources. In some implementations, some or all of the functionality attributed herein to external resources 150 may be provided by resources included in system 100.

Server(s) 102 may include electronic storage 152, one or more processors 154, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 152 may comprise non-transitory storage media that electronically stores information. The electronic storage media of electronic storage 152 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 152 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 152 may include one or more virtual storage resources (e.g., cloud storage, a virtual private network, and/or other virtual storage resources). Electronic storage 152 may store software algorithms, information determined by processor(s) 154, information received from server(s) 102, information received from client computing platform(s) 104, and/or other information that enables server(s) 102 to function as described herein.

Processor(s) 154 may be configured to provide information processing capabilities in server(s) 102. As such, processor(s) 154 may include one or more of a digital processor, an analog processor, a digital circuit designed to process information, an analog circuit designed to process information, a state machine, and/or other mechanisms for electronically processing information. Although processor(s) 154 is shown in FIG. 1 as a single entity, this is for illustrative purposes only. In some implementations, processor(s) 154 may include a plurality of processing units. These processing units may be physically located within the same device, or processor(s) 154 may represent processing functionality of a plurality of devices operating in coordination. Processor(s) 154 may be configured to execute modules 108, 110, 112, 114, 116, 118, 120, 122, 124, 126, 128, 130, 132, 134, 136, 138, 140, 142, 144, 146, and/or 148, and/or other modules. Processor(s) 154 may be configured to execute modules 108, 110, 112, 114, 116, 118, 120, 122, 124, 126, 128, 130, 132, 134, 136, 138, 140, 142, 144, 146, and/or 148, and/or other modules by software; hardware; firmware; some combination of software, hardware, and/or firmware; and/or other mechanisms for configuring processing capabilities on processor(s) 154. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 108, 110, 112, 114, 116, 118, 120, 122, 124, 126, 128, 130, 132, 134, 136, 138, 140, 142, 144, 146, and/or 148 are illustrated in FIG. 1 as being implemented within a single processing unit, in implementations in which processor(s) 154 includes multiple processing units, one or more of modules 108, 110, 112, 114, 116, 118, 120, 122, 124, 126, 128, 130, 132, 134, 136, 138, 140, 142, 144, 146, and/or 148 may be implemented remotely from the other modules. The description of the functionality provided by the different modules 108, 110, 112, 114, 116, 118, 120, 122, 124, 126, 128, 130, 132, 134, 136, 138, 140, 142, 144, 146, and/or 148 described below is for illustrative purposes, and is not intended to be limiting, as any of modules 108, 110, 112, 114, 116, 118, 120, 122, 124, 126, 128, 130, 132, 134, 136, 138, 140, 142, 144, 146, and/or 148 may provide more or less functionality than is described. For example, one or more of modules 108, 110, 112, 114, 116, 118, 120, 122, 124, 126, 128, 130, 132, 134, 136, 138, 140, 142, 144, 146, and/or 148 may be eliminated, and some or all of its functionality may be provided by other ones of modules 108, 110, 112, 114, 116, 118, 120, 122, 124, 126, 128, 130, 132, 134, 136, 138, 140, 142, 144, 146, and/or 148. As another example, processor(s) 154 may be configured to execute one or more additional modules that may perform some or all of the functionality attributed below to one of modules 108, 110, 112, 114, 116, 118, 120, 122, 124, 126, 128, 130, 132, 134, 136, 138, 140, 142, 144, 146, and/or 148.

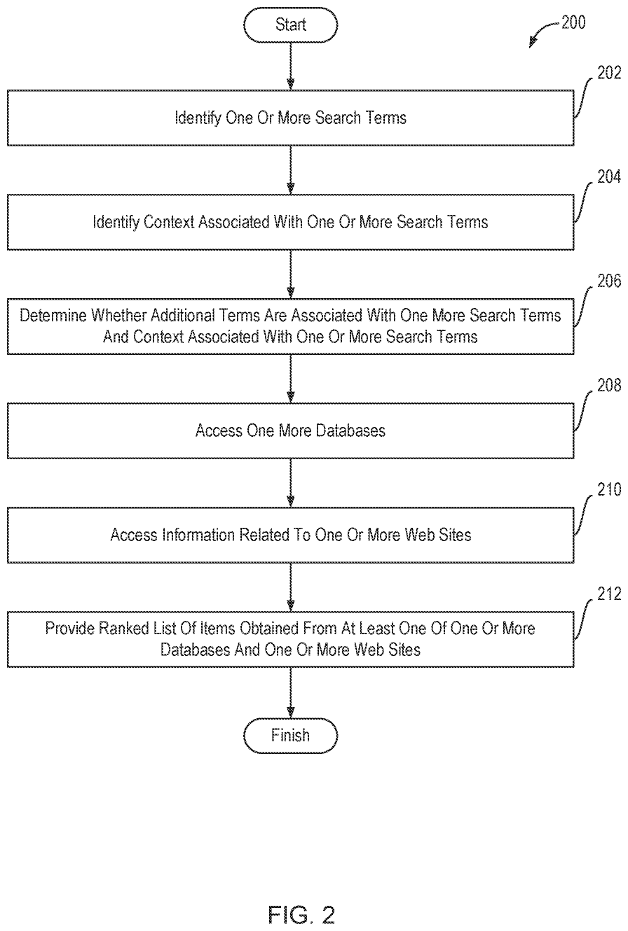

FIG. 2 illustrates a method 200 for searching one or more data sources, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

A first operation 202 may include identifying one or more search terms (e.g., database crash). First operation 202 may be performed by one or more hardware processors configured by machine-readable instructions including a module that is the same as or similar to search term identifying module 108, in accordance with one or more implementations.

A second operation 204 may include identifying a context associated with the one or more search terms (e.g., issue or malfunction encountered while trying to access a database, database abruptly closes). Second operation 204 may be performed by one or more hardware processors configured by machine-readable instructions including a module that is the same as or similar to context identifying module 110, in accordance with one or more implementations.

A third operation 206 may include determining whether additional terms are associated with the one more search terms and the context associated with the one or more search terms. As an example, if the majority of data (e.g., resolved tickets, case studies, prior search queries, etc.) for the term “database crash” are associated with a specific enterprise software system, such as ORACLE, the system (e.g., system 100) ranks results/items related to ORACLE as higher (e.g., lists them at or near the top of a ranked list) as compared to results/items pertaining to another enterprise software system (e.g., SAP). It should be noted that the order in which the search results/items are listed in a ranked list may also vary depending on any constraints specified by the user. For instance, a user may enter the search term “database crash” and specify “SAP” as a constraint, in which case the system outputs results/items that are associated with SAP database crashes near the top of the ranked list. In some cases, the system may refrain from displaying results associated with other enterprise software systems (e.g., JDE or ORACLE), or alternatively, assign a lower rank to such results. Third operation 206 may be performed by one or more hardware processors configured by machine-readable instructions including a module that is the same as or similar to term determination module 112, in accordance with one or more implementations.

A fourth operation 208 may include accessing one more databases, further described below in relation to FIGS. 3-5. Fourth operation 208 may be performed by one or more hardware processors configured by machine-readable instructions including a module that is the same as or similar to database accessing module 114, in accordance with one or more implementations.

A fifth operation 210 may include accessing information related to one or more web sites, further described below in relation to FIGS. 3-5. Fifth operation 210 may be performed by one or more hardware processors configured by machine-readable instructions including a module that is the same as or similar to web site accessing module 116, in accordance with one or more implementations.

A sixth operation 212 may include providing a ranked list of items obtained from at least one of the one or more databases and the one or more web sites. The ranked list of items may include items related to the one or more search terms (e.g., one or more tickets associated with database crashes). Sixth operation 212 may be performed by one or more hardware processors configured by machine-readable instructions including a module that is the same as or similar to list providing module 118, in accordance with one or more implementations.

FIG. 3 illustrates a swim diagram 300 directed to a method for searching for one or more data sources, according to various aspects of the disclosure. In some examples, the operations described in relation to FIG. 3 may be implemented using the various instruction modules of system 100.

Step 321 comprises receiving, at a computing platform 302, a search query from a user device 304. In some cases, the search query may include one or more search terms. At step 322, the computing platform 302 identifies one or more search terms in the search query. As an example, the search query may comprise “database crash”, and the search terms extracted from the search query may include “database”, “DB”, “SQL”, “data base”, “crash”, “crashed”, “abort”, “malfunction”, and/or “failure”, to name a few non-limiting examples.

Additionally, at step 323, the computing platform 302 identifies a context associated with the one or more search terms. The computing platform 302 may also determine, at step 324, whether additional terms are associated with the one or more search terms and/or the context associated with the one or more search terms. In some cases, step 324 is optional (shown as optional by the dashed lines). In some embodiments, the one or more search terms comprise natural language search terms. Additionally, in some embodiments, identifying a context (step 323) associated with the one or more search terms comprises, for at least one of the search terms, applying another of the search terms to identify a meaning of the at least one of the search terms.

In some cases, the computing platform 302 is electronically, logically, and/or communicatively coupled to one or more data sources 308. As seen in FIG. 3, the data sources 308 may comprise one or more databases 310 (e.g., database 310-a, database 310-b, database 310-c, database 310-d) and one or more web sites 311. As shown, at step 325, the computing platform 302 accesses the one or more databases 310. Additionally, at step 326, the computing platform 302 accesses information related to the one or more web sites 311. In some cases, the one or more databases comprise a ticketing system database involving one or more topics (e.g., database 310-a), a database comprising client information (e.g., database 310-b), an internal resource database (e.g., database 310-c), and a general database (e.g., database 310-d). Some non-limiting examples of web sites 311 comprise a web and application management web site, a network monitoring website, a database software website, and an enterprise software website.

In some cases, the ticketing system database (e.g., database 310-a) comprises a first Jira cloud database and first information related to a customer. Additionally, the database comprising client information (e.g., database 310-b) comprises a second Jira cloud database and second information related to a customer. In some examples, the second information related to the customer is different from the first information related to the customer. The internal resource database (e.g., database 310-c) comprises information related to individuals (e.g., technical support personnel) associated with an entity (e.g., an organization providing third-party software support), availability of the individuals, and one or more subject matters associated with the individuals. In some cases, the general database (e.g., database 310-d) comprises one or more of (1) descriptions of at least some of the one or more topics, where at least some of the descriptions comprise a guides and books, (2) customer information, (3) process information, and (4) employee information. In some embodiments, the first information related to a customer comprises one or more of a problem and a question (e.g., ORACLE database crashing) associated with one or more of a system associated with a customer and a third-party system. Some non-limiting examples of the topics comprise an enterprise software system (e.g., ORACLE CORPORATION from Austin, TX, JD EDWARDS or JDE from Denver, CO—acquired by ORACLE CORPORATION), tax information, governmental compliance information, and/or regulatory information. Other types of topics are contemplated in different embodiments and the examples listed herein are not intended to be limiting. In some cases, a taxonomy may be implemented for the one or more search terms, for instance, prior to identifying the one or more search terms at step 322. In some cases, the taxonomy comprises associating one or more words with at least one of the one or more search terms. As an example, implementing the taxonomy may comprise associating words having alternate spellings (e.g., British vs American English), such as “realize” or “utilize” with said alternate spellings (e.g., realise, utilise) such that they are considered to be equivalent.

In this way, the present disclosure allows the use of one or more disparate data sources (e.g., web sites, databases), artificial intelligence techniques (e.g., machine learning or ML), and/or customized taxonomy to provide enterprise software support for third-party software applications. In some cases, a user may utilize the system (e.g., system 100, system 400) to search the disparate sources for similar or substantially similar issues encountered (or researched) in the past, for instance, for providing technical support for a third-party software application. By ranking the list of items, e.g., based on user input and/or determining the order in which items or results are accessed, the system refines the search and ranking methodology over time and enhances the relevancy of search results/items displayed to the user. As an example, the system may receive a search query, or one or more search terms, related to an issue (or alternatively, a question) for a client. For example, the one or more search terms may correspond to “a new customer setup for Jira”, “database crashing”, or “a request for performing tuning analysis on a customer's database”, to name a few non-limiting examples. The user (e.g., third-party technical support representative) can input the search query or one or more search terms into the system, where the one or more search terms comprise natural language search terms. The system then outputs a ranked list of items, tracks or monitors user input, including at least the order in which the items/results are accessed by the user, determines the relevancy of the results/items presented to the user based at least in part on tracking or monitoring the user input, and optionally updates the search and ranking methodology (e.g., for future search queries). In some aspects, the system identifies a weighting for each item of the ranked list of items based on tracking the user input. Additionally, the system displays the item having the highest weighting at or near the top (i.e., implying that the item is more relevant) of another ranked list in response to a future search utilizing the same or similar search terms. The system of the present disclosure also helps compare the search results or items from different data sources, including at least quantitatively determining their quality and/or relevance in relation to other data sources. In some examples, the system (e.g., system 100) stores information related to one or more users of the system, including, but not limited to, how the user uses the system (e.g., does user typically enter natural language search terms, does user typically enter error codes, etc.), user profile information (e.g., engineer, sales representative, marketing, technical sales, R&D, etc.), or any other applicable information. Furthermore, the system utilizes this user-specific information to customize one or more aspects of the ranked list, including at least the order in which the results/items are displayed. In one non-limiting example, the system 100 ranks the results using a relevancy model for the user, where the relevancy model is used to predict which of said results/items a user is more likely to lean towards (i.e., find more relevant). For instance, the system may display (at or near the top of a ranked list) a result/item comprising a snippet of code (e.g., where the code may need some modification to suit the customer's needs) based on determining that the user has a technical/coding background and/or gravitates towards such results (e.g., technical/complex, but faster) based on tracking and monitoring their prior selections. Similarly, the system may display one or more results/items comprising a high-level description of the underlying problem (i.e., root cause) related to the customer's ticket, the result comprising the snippet of code, and one or more results/items related to modifying the code and/or testing the code, based on determining that the user entering the search terms does not have a technical/coding background, or prefers a high-level view of the problem before converging on a solution.

In some cases, at step 327, the computing platform 302 provides a ranked list of items obtained from at least one of the one or more databases and the one or more web sites, where the ranked list of items comprises items (e.g., tickets, documents, such as PDF files or Spreadsheets, whitepapers, case studies, etc.) related to the one or more search terms. In some cases, the ranked list of items may comprise a display of items on a user device or computing device, such as user device 304.

Aspects of the disclosure are directed to a computing platform or system that leverages artificial intelligence (AI) and machine learning (ML) techniques for providing technical support for third-party software applications. In some cases, AI and/or ML can facilitate reducing the resolution time for service incidents, as compared to prior art techniques. Specifically, the system of the present disclosure utilizes natural language processing (NLP) to run statistical and ML models on input data (e.g., search terms, tickets, case studies, and any other information relevant to the third-party enterprise software), where the statistical and ML models are used to train the system in searching and ranking items in response to receiving one or more search terms from a user. The system (e.g., systems 100, 400) comprises a search engine (shown as search system 502 in FIG. 5) based on natural language search that is configured to provide relevant service incident tickets, case studies, solutions, etc., to a technical support user.

FIG. 4 illustrates an example of a system 400 for searching one or more data sources, according to various aspects of the disclosure. The system 400 implements one or more aspects of the system 100 previously described in relation to FIG. 1 and comprises a computing platform 402 (or server 402), a user device 404, one or more data sources 408, and a third-party system 442. In some cases, the various elements (or sub-systems) of system 400 may be electronically, logistically, and/or communicatively coupled using one or more communication links 441. For example, the user device 404, which may be similar or substantially to the remote computing platform 104 in FIG. 1, may communicate with the computing platform 402 using a communication link 441-a. Additionally, the computing platform 402 may be in communication with the one or more data sources 408 using a communication link 441-b and the third-party system 442 using a communication link 441-c. The one or more data sources 408 may include one or more databases 410, such as a ticketing system database 410-a, a database 410-b comprising client information, an internal resource database 410-c, and/or a general database 410-d. One or more of the databases shown in FIG. 4 may be optional. The one or more data sources 408 may also include one or more websites 411, such as, but not limited to, a web and application management web site, a network monitoring web site, a database software web site, and an enterprise software web site. In some cases, the ticketing system database 410-a comprises data/information associated with (or involving) one or more topics. The one or more topics may include an enterprise software system (e.g., shown as third-party system 442), tax information, governmental compliance information, and/or regulatory information to name a few non-limiting examples.

In some examples, the system 400 helps enhance the relevancy of search results provided by a search system in response to receiving one or more search terms from a user, where the one or more search terms may be associated with a technical support issue raised by a client, for instance, for an enterprise software application associated with the third-party system 442. The system allows customer support teams to review and research issues or problems experienced by clients, where the reviewing comprises searching the issue or problem using the search system (e.g., search system 502) of the present disclosure. In some cases, searching the issue or problem comprises receiving, at the system 400, one or more search terms from a user, where the one or more search terms comprise natural language search terms. In some circumstances, the system 400 can also help reduce resolution time, as compared to the prior art, where the resolution time corresponds to the time needed to identify a solution to a technical issue.

In some cases, the computing platform 402 comprises one or more software or instruction modules, such as the ones described in relation to FIG. 1. For example, the computing platform 402 comprises a website crawling module (e.g., shown as website crawling module 120 in FIG. 1) that is configured to crawl through one or more web sites 411. The website crawling module (or another module of computing platform 402) may be configured to access information related to the one or more websites, where the accessed information is used to generate a list of items (e.g., a ranked list of items) displayed on the user device 404. In some examples, the computing platform 402 also comprises a database accessing module (e.g., shown as database accessing module 114 in FIG. 1) and other instruction modules that are configured to access and search the one or more databases 410. In addition to crawling the one or more websites, accessing information related to the one or more websites also comprises finding information related to at least one of the one or more topics (e.g., an enterprise software system, such as ORACE or J.D. EDWARDS) and the one or more search terms. In some cases, accessing the website information also includes one or more of indexing and pointing to the information related to the one or more topics and/or the one or more search terms.

In some cases, the one or more data sources 408 (e.g., databases 410, websites 411) are compared against a taxonomy to identify one or more items/results that are more likely to relate to the one or more search terms. For instance, the terms “JDE”, “JD EDWARDS”, “J.D.E.” may be used interchangeably for the JD EDWARDS enterprise software system. As noted above, the taxonomy may be implemented for one or more search terms, where the taxonomy or classification comprises associating one or more words with at least one of the one or more search terms. As an example, the terms “DB”, “DBA”, and “Database” may be associated with the term “database”. In such cases, when the user enters the phrase “database crash” into the search field, the system outputs “tickets”, “knowledge base articles”, and “web posts” associated with (or related to) a database crash.

FIG. 5 illustrates an example of a process flow 500 directed to a method for searching one or more data sources, according to various aspects of the disclosure. The process flow 500 described in relation to FIG. 5 may be implemented using any of the systems described herein, including at least systems 100 and/or 400 described in relation to FIGS. 1 and/or 4, respectively. In this example, the one or more data sources are shown by way of databases 510 (e.g., databases 510-a, 510-b, 510-c, 510-d, 510-e, and/or 510-f) and external web sites 511 (e.g., external web sites 511-a, 511-b). It should be noted that, the number of databases and external websites depicted in FIG. 5 are not intended to be limiting. In some cases, the database 510-a may be an example of an internal resource database, the database 510-b may be an example of a Jira cloud database, the database 510-c may be an example of an ACTIVE DIRECTORY (AD) database, the database 510-d may be an example of a SHAREPOINT database, the database 510-d may be an example of a SMARTSHEET database, and the database 510-f may be an example of a SALESFORCE database. Other types of databases known in the art are contemplated in different embodiments.

As shown, a search system 502 is electronically, logistically, and/or communicatively coupled to the one or more data sources. The search system 502 also receives information related to one or more current processes for solving customer tickets (551). In one non-limiting example, the process comprises receiving a search query (i.e., one or more search terms), parsing the search query, identifying a context (e.g., by performing NLP on the one or more terms in the search query, by analyzing a proximity of words in the search query, based on referencing a thesaurus or dictionary to identify alternate terms to those used in the search query, and/or based on a specific error code, product category, or subject matter referenced in the search query, to name a few non-limiting examples), and displaying a list of items directed to some potential “root causes” that may be linked to the customer's issue. Additionally, or alternatively, the process for solving customer tickets (551) comprises receiving the search query, parsing the search query, identifying the context, and displaying a list of items (i.e., potential solutions) for solving the customer's problem. In the latter case, one or more of the potential solutions may be associated with a different root cause, as it may be possible for different root causes to manifest in the same “symptom”. For instance, solutions A, B, and C, may have previously been employed to address root causes D, E, and F, respectively, even though the root causes (i.e., D, E, and F) resulted in the same or similar customer issue (i.e., symptom). Furthermore, in the former case, a same or similar solution may have been employed to address the same “symptom”, even though the root causes were not identical. For example, a common solution G may have been previously employed to address multiple customer issues (or problems), in spite of them being associated with a different root cause/underlying problem. Thus, as described above, the search system 502 utilizes the information related to the various processes (e.g., for finding root cause(s) and potential solution(s)) for solving customer tickets.

In some examples, a user utilizes the search system 502 to simultaneously query the plurality of data sources (552). In some cases, the user may remotely access the search system 502, for instance, using another computing device (e.g., remote computing platform 104 in FIG. 1). Alternatively, the search system 502 may include a user interface (UI) or graphical user interface (GUI), and the user may directly query the one or more data sources using the UI of the search system 502. At decision block 553, the process flow 500 comprises determining whether the issue/problem corresponding to the one or more search terms is resolved. If yes, the process flow 500 comprises closing the ticket (556). If no, the process flow 500 comprises further research and/or troubleshooting (554) until the ticket or issue is solved (555). Once the ticket is resolved (555), the process flow 500 comprises closing the ticket (558).

In some cases, the user may access a plurality of links (e.g., HTML, link to a service ticket), documents, guides, and/or books presented by the search system 502 in at least one ranked list of items on their user device (e.g., shown as user device 304 in FIG. 3). In some cases, at least a portion of items in the at least one ranked list of items may have been displayed in at least one prior search (e.g., by the same or a different user). In some cases, a ranked list of items may also include one or more new results or items, where the one or more new items may comprise one or more items (e.g., links, documents, guides, books, information associated with a customer or service ticket, etc.) that have not (1) appeared in prior searches, (2) not been indexed or cached by the search system 502 in the one or more databases, (3) not been previously accessed, e.g., clicked on, by the user performing the search, or (4) a combination thereof.

In some cases, process flow 500 further comprises updating the one or more data sources to include the one or more new items (559), where the updating may be performed in response to the additional research and/or troubleshooting (554). In some embodiments, process flow 500 also comprises collecting information (557), the information pertaining to new tickets, whitepapers, products, and/or security updates. It should be noted that, these new tickets (or service tickets) may have been generated by the same or a different user of the search system 502. Additionally, the tickets, whitepapers, products, and/or security updates may be associated with an enterprise software application, such as, but not limited to, ORACLE, SAP, and/or JD EDWARDS. In some cases, the tickets described herein may comprise service tickets for addressing technical support issues. As shown in FIG. 5, process flow 500 also comprises updating (558) the one or more data sources, based at least in part on the information related to the one or more current processes for solving customer tickets (551) and/or the information related to the new solutions or items (557). In some cases, the one or more data sources (e.g., databases 510) may be updated as new information for solving customer tickets is made available. In other cases, the one or more data sources are updated periodically (e.g., once a day, every 8 hours, every 1 hour, to name a few).

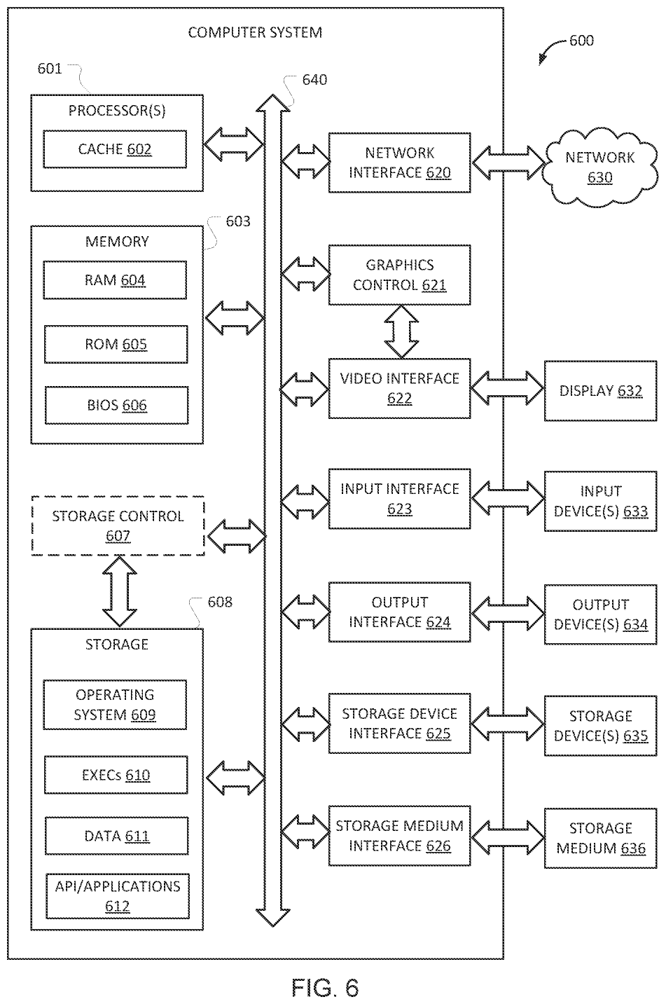

FIG. 6 illustrates a diagrammatic representation of one embodiment of a computer system 600, within which a set of instructions can execute for causing a device to perform or execute any one or more of the aspects and/or methodologies of the present disclosure. The components in FIG. 6 are examples only and do not limit the scope of use or functionality of any hardware, software, firmware, embedded logic component, or a combination of two or more such components implementing particular embodiments of this disclosure. Some or all of the illustrated components can be part of the computer system 600. For instance, the computer system 600 can be a general-purpose computer (e.g., a laptop computer) or an embedded logic device (e.g., an FPGA), to name just two non-limiting examples.

Moreover, the components may be realized by hardware, firmware, software or a combination thereof. Those of ordinary skill in the art in view of this disclosure will recognize that if implemented in software or firmware, the depicted functional components may be implemented with processor-executable code that is stored in a non-transitory, processor-readable medium such as non-volatile memory. In some embodiments, the non-volatile memory unit stores instructions and/or data even when the computer system 600 is off In addition, those of ordinary skill in the art will recognize that hardware such as field programmable gate arrays (FPGAs) may be utilized to implement one or more of the constructs depicted herein.

Computer system 600 includes at least a processor 601 such as a central processing unit (CPU), a graphics processing unit (GPU), another processor or logic device, such as a complex instruction set computer (CISC) microprocessor, a reduced instruction set computing (RISC) microprocessor, a very long instruction word (VLIW) microprocessor, an x86 instruction set compatible processor, a processor implementing a combination of instruction sets, a multi-core processor such as a dual-core processor or dual-core mobile processor, or any other microprocessor or central processing unit (CPU). The processor 601 may also be implemented as a dedicated processor, such as a controller, a microcontroller, an embedded processor, a chip multiprocessor (CMP), a co-processor, a digital signal processor (DSP), a network processor, a media processor, an input/output (I/O) processor, a media access control (MAC) processor, a radio baseband processor, an application specific integrated circuit (ASIC), a field programmable gate array (FPGA), a programmable logic device (PLD), and so forth. The embodiments are not limited in this context. Any of the subsystems described throughout this disclosure could embody the processor 601.

The computer system 600 may also comprise a memory 603 and a storage 608, both communicating with each other, and with other components, via a bus 640 (e.g., a wired and/or wireless bus). The bus 640 may also link a display 632, one or more input devices 633 (which may, for example, include a keypad, a keyboard, a mouse, a stylus, etc.), one or more output devices 634, one or more storage devices 635, and various non-transitory, tangible computer-readable storage media 636 with each other and/or with one or more of the processor 601, the memory 603, and the storage 608. All of these elements may interface directly or via one or more interfaces or adaptors to the bus 640. For instance, the various non-transitory, tangible computer-readable storage media 636 can interface with the bus 640 via storage medium interface 626.

Computer system 600 may have any suitable physical form, including but not limited to one or more integrated circuits (ICs), printed circuit boards (PCBs), mobile handheld devices (such as mobile telephones or PDAs), desktop computers, tablet computers, laptop or notebook computers, distributed computer systems, computing grids, user equipment (e.g., a smart phone), a server, a server array or server farm, a web server, a network server, an Internet server, a main frame computer, a supercomputer, a network appliance, a web appliance, a distributed computing system, consumer electronics, programmable consumer electronics, etc. Accordingly, functions and/or specific configurations of computer system 600 described herein may be included or omitted based on use case. In some embodiments, computer system 600 may be configured to be compatible with protocols and frequencies associated with one or more of the 3GPP LTE Specifications, IEEE 802.16 Standards, and IEEE 802.11 Standards for WLANs, and/or other broadband wireless networks cited herein although the embodiments are not limited in this respect. In some embodiments, computer system 600 may utilize a single input single output (SISO) architecture for communications. However, certain implementations may include multiple antennas for transmission and/or reception using adaptive antenna techniques for beamforming or spatial division multiple access (SDMA) and/or using multiple input multiple output (MIMO) communication techniques.

Processor(s) 601 (or central processing unit 601) optionally contains a cache memory unit 632 for temporary local storage of instructions, data, or computer addresses. Processor(s) 601 are configured to assist in execution of computer-readable instructions stored on at least one non-transitory, tangible computer-readable storage medium. It should be noted that, if the processor 601 includes more than one processing device, the processing devices may be centrally located (e.g., directly coupled together via a wired and/or wireless bus structure) or may be located in a distributed manner (e.g., cloud computing or indirect coupling via a local area network and/or a wide area network). Computer system 600 may provide functionality as a result of the processor(s) 601 executing software (e.g., software components, programs, applications, operating system software, middleware, firmware, routines and/or sub-routines, API, instruction sets, etc.) embodied in one or more non-transitory, tangible computer-readable storage media, such as memory 603, storage 608, storage devices 635, and/or storage medium 636 (e.g., read only memory (ROM)). In some embodiments, memory 603 may read the software from one or more other non-transitory, tangible computer-readable storage media (such as mass storage device(s) 635, 636) or from one or more other sources through a suitable interface, such as network interface 620. Any of the subsystems herein disclosed could include a network interface such as the network interface 620. The software may cause processor(s) 601 to carry out one or more processes or one or more steps of one or more processes described or illustrated herein. Carrying out such processes or steps may include defining data structures stored in memory 603 and modifying the data structures as directed by the software. In some embodiments, an FPGA can store instructions for carrying out functionality as described in this disclosure. In other embodiments, firmware includes instructions for carrying out functionality as described in this disclosure. Further note that when the processor 601 implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element stores, and the processor 601 executes, hard coded and/or operational instructions corresponding to at least some of the steps and/or functions illustrated in FIGS. 2, 3, and/or 5.

The memory 603 may include various components (e.g., non-transitory, tangible computer-readable storage media) including, but not limited to, a random-access memory component (e.g., RAM 604, such as a static RAM “SRAM”, a dynamic RAM “DRAM”, a double-data-rate DRAM “DDRAM”, a synchronous DRAM “SDRAM”, etc.), a read-only component (e.g., ROM 605), and any combinations thereof. ROM 605 may act to communicate data and instructions unidirectionally to processor(s) 601, and RAM 604 may act to communicate data and instructions bidirectionally with processor(s) 601. ROM 605 and RAM 604 may include any suitable non-transitory, tangible computer-readable storage media. In some instances, ROM 605 and RAM 604 include non-transitory, tangible computer-readable storage media for carrying out a method, such as method 200 in FIG. 2. In one example, a basic input/output system 606 (BIOS), including basic routines that help to transfer information between elements within computer system 600, such as during start-up, may be stored in the memory 603.

Fixed storage 608 is connected bi-directionally to processor(s) 601, optionally through storage control unit 607. Fixed storage 608 provides additional data storage capacity and may also include any suitable non-transitory, tangible computer-readable media described herein. Storage 608 may be used to store operating system 6010, EXECs 610 (executables), data 611, API applications 612 (application programs), and the like. Often, although not always, storage 608 is a secondary storage medium (such as a hard disk) that is slower than primary storage (e.g., memory 603). Storage 608 can also include an optical disk drive, a solid-state memory device (e.g., flash-based systems), or a combination of any of the above. Information in storage 608 may, in appropriate cases, be incorporated as virtual memory in memory 603.

In one example, storage device(s) 635 may be removably interfaced with computer system 600 (e.g., via an external port connector (not shown)) via a storage device interface 625. Particularly, storage device(s) 635 and an associated machine-readable medium may provide nonvolatile and/or volatile storage of machine-readable instructions, data structures, program modules, and/or other data for the computer system 600. In one example, software may reside, completely or partially, within a machine-readable medium on storage device(s) 635. In another example, software may reside, completely or partially, within processor(s) 601.

Bus 640 connects a wide variety of subsystems. Herein, reference to a bus may encompass one or more digital signal lines serving a common function, where appropriate. Bus 640 may be any of several types of bus structures including, but not limited to, a memory bus, a memory controller, a peripheral bus, a local bus, and any combinations thereof, using any of a variety of bus architectures. As an example, and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof. In some cases, the bus 640 may utilize a wired and/or wireless bus structure.

Computer system 600 may also include an input device 633. In one example, a user of computer system 600 may enter commands and/or other information into computer system 600 via input device(s) 633. Examples of an input device(s) 633 include, but are not limited to, an alpha-numeric input device (e.g., a keyboard), a pointing device (e.g., a mouse or touchpad), a touchpad, a touch screen and/or a stylus in combination with a touch screen, a joystick, a gamepad, an audio input device (e.g., a microphone, a voice response system, etc.), an optical scanner, a video or still image capture device (e.g., a camera), and any combinations thereof. Input device(s) 633 may be interfaced to bus 640 via any of a variety of input interfaces 623 (e.g., input interface 623) including, but not limited to, serial, parallel, game port, USB, FIREWIRE, THUNDERBOLT, or any combination of the above.

In particular embodiments, when computer system 600 is connected to network 630, computer system 600 may communicate with other devices, such as mobile devices and enterprise systems, connected to network 630. Communications to and from computer system 600 may be sent through network interface 620. For example, network interface 620 may receive incoming communications (such as requests or responses from other devices) in the form of one or more packets (such as Internet Protocol (IP) packets) from network 630, and computer system 600 may store the incoming communications in memory 603 for processing. Computer system 600 may similarly store outgoing communications (such as requests or responses to other devices) communicated to network 630 from network interface 620 in the form of one or more packets in memory 603. Processor(s) 601 may access these communication packets stored in memory 603 for processing.

Examples of the network interface 620 include, but are not limited to, a network interface card, a modem, and any combination thereof. Examples of a network 630 or network segment 630 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 630, may employ a wired and/or a wireless mode of communication. In general, any network topology may be used. For example, in some cases, the network interface 620 may comprise a radio frequency (RF) transceiver and one or more RF antennas. RF transceiver may include one or more radios capable of transmitting and receiving signals using various suitable wireless communications techniques. Such techniques may involve communications across one or more wireless networks, such as any of the aforementioned example wireless networks, according to one or more wireless communications technology and/or standards, such as any of the aforementioned example wireless communications technologies and/or standards. Examples of RF antennas may include internal antennas, omni-directional antennas, monopole antennas, dipole antennas, end-fed antennas, circularly polarized antennas, micro-strip antennas, diversity antennas, dual antennas, tri-band antennas, quad-band antennas, and so forth. The embodiments are not limited to these examples.

Information and data can be displayed through a display 632. Examples of a display 632 include, but are not limited to, a liquid crystal display (LCD), an organic liquid crystal display (OLED), a cathode ray tube (CRT), a plasma display, and any combinations thereof. The display 632 can interface to the processor(s) 601, memory 603, and fixed storage 608, as well as other devices, such as input device(s) 633, via the bus 640. The display 632 is linked to the bus 640 via a video interface 622, and transport of data between the display 632 and the bus 640 can be controlled via the graphics control 621.

In addition to a display 632, computer system 600 may include one or more other peripheral output devices 634 including, but not limited to, an audio speaker or a printer. Such peripheral output devices may be connected to the bus 640 via an output interface 624. Examples of an output interface 624 include, but are not limited to, a serial port, a parallel connection, a USB port (e.g., micro-USB, mini-USB, USB C, to name a few non-limiting examples), a FIREWIRE port, a THUNDERBOLT port, and any combinations thereof.

In addition, or as an alternative, computer system 600 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a non-transitory, tangible computer-readable medium may encompass a circuit (such as an integrated circuit or IC) storing software for execution, a circuit embodying logic for execution, or both, where appropriate. The present disclosure encompasses any suitable combination of hardware, software, or both.

Those of skill in the art will understand that information and signals may be represented using any of a variety of different technologies and techniques. Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, a software module implemented as digital logic devices, or in a combination of these. A software module (or instruction module) may reside in RAM memory, flash memory, ROM memory, erasable programmable ROM (EPROM) memory, electrically erasable programmable (EEPROM) memory, registers, hard disk, a removable disk, a read-only or rewritable compact disc (i.e., CD-ROM, CD-R, or CD-RW), flash memory (e.g., SD cards, mini-SD cards, micro-SD cards, etc.), magnetic and/or solid state hard drives, read-only and recordable BLURAY discs, ultra-density optical discs, or any other form of non-transitory, tangible computer-readable storage medium known in the art. An exemplary non-transitory, tangible computer-readable storage medium is coupled to the processor such that the processor can read information from, and write information to, the non-transitory, tangible computer-readable storage medium. The processor 601 may be a single processor or a multi-core processor (e.g., a dual-core processor, a quad-core processor, a hexa-core processor, an octa-core processor, to name a few non-limiting examples) in different embodiments. In some other cases, the instructions may be passed to and executed by a GPU. The GPU may be configured to offload various computations or complement the processing provided by the processor 601. In the alternative, the non-transitory, tangible computer-readable storage medium may be integral to the processor. The processor and the non-transitory, tangible computer-readable storage medium may reside in an ASIC. Furthermore, the ASIC may reside in a user terminal. In the alternative, the processor and the non-transitory, tangible computer-readable storage medium may reside as discrete components in a user terminal.

It is contemplated that one or more of the components or subcomponents described in relation to the computer system 600 shown in FIG. 6 such as, but not limited to, the network 630, processor 601, memory, 603, etc., may comprise a cloud computing system. In one such system, front-end systems such as input devices 633 may provide information to back-end platforms such as servers (e.g., computer systems 600) and storage (e.g., memory 603). Software (i.e., middleware) may enable interaction between the front-end and back-end systems, with the back-end system providing services and online network storage to multiple front-end clients. For example, a software-as-a-service (SAAS) model may implement such a cloud-computing system. In such a system, users may operate software located on back-end servers through the use of a front-end software application such as, but not limited to, a web browser.

As used in this specification and any claims of this application, the terms “computer”, “server”, “processor”, and “memory” all refer to electronic or other technological devices. These terms exclude people or groups of people. For the purposes of the specification, the terms “display” or “displaying” means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the disclosure has been described with reference to numerous specific details, one of ordinary skill in the art will recognize that the disclosure can be embodied in other specific forms without departing from the spirit of the disclosure. In addition, a number of the figures (including FIGS. 2, 3, 5) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured for searching one or more data sources, the system comprising:
one or more hardware processors configured by machine-readable instructions to:
identify one or more search terms;
identify a context associated with the one or more search terms;
determine whether additional terms are associated with the one more search terms and the context associated with the one or more search terms;
access one more databases;
access information related to one or more web sites; and
provide a ranked list of items obtained from at least one of the one or more databases and the one or more web sites, wherein the ranked listed comprises items related to the one or more search terms.

2. The system of claim 1, wherein prior to identifying one or more search terms, the one or more hardware processors are further configured by machine-readable instructions to:
implement a taxonomy for the one or more search terms, wherein the taxonomy comprises associating one or more words with at least one of the one or more search terms;
wherein the one or more databases comprise a ticketing system database involving one or more topics, a database comprising client information, an internal resource database, and a general database;
and wherein accessing information related to one or more web sites comprises;
crawling the one or more web sites;
finding information related to at least one of the one or more topics and the one or more search terms; and
at least one of indexing and pointing to the information related to the at least one of the one or more topics and the one or more search terms.

3. The system of claim 2, wherein,
the ticketing system database comprises a first Jira cloud database and first information related to a customer;
the database comprising client information comprises a second Jira cloud database and second information related to a customer, wherein the second information related to a customer is different from the first information related to a customer;
the internal resource database comprises information related to individuals associated with an entity, availability of the individuals, and one or more subject matters associated with the individuals;
the general database comprises descriptions of at least some of the one or more topics, wherein at least some of the descriptions comprise a guides and books, customer information, process information, and employee information;
the one or more web sites comprise one or more of a web and application management website, a network monitoring website, a database software website, and an enterprise software website;
the one or more search terms comprise natural language search terms; and
identifying a context associated with the one or more search terms comprises for at least one of the one or more search terms applying another of the one or more search terms to identify a meaning of the at least one of the one or more search terms.

4. The system of claim 3, wherein the first information related to a customer comprises one or more of a problem and a question associated with one or more of a system associated with a customer and a third-party system; and
wherein the one or more topics comprises an enterprise software system, tax information, and one of governmental compliance information and regulatory information.

5. The system of claim 3, wherein applying the another of the one or more search terms to identify a meaning of the at least one of the one or more search terms comprises accessing a data store;
wherein using the another of the one or more search terms to identify a meaning of the at least one of the one or more search terms comprises finding in the data store one or more prior definitions of the at least one of the one or more search terms when used with the another of the one or more search terms and any additional terms associated with the another of the one or more search terms; and
wherein using the another of the one or more search terms to identify a meaning of the at least one of the one or more search terms comprises using the another of the one or more search terms, the one or more prior definitions, and the at least one of the one or more search terms to obtain a definition of the at least one of the one or more search terms.

6. The system of claim 1, wherein accessing one more databases and accessing information related to one or more web sites comprises selecting one of the one or more databases and the one or more web sites to access and read data and metadata associated with the one or more databases and the one or more web sites;
wherein the ranked list of items comprises a display of items;
wherein one of a top item and a first item in the display of items comprises an item most likely to relate to the one or more search terms;
wherein one of a bottom item and a last item in the display of items comprises an item least likely to relate to the one or more search terms.

7. The system of claim 6, wherein,
the metadata comprises one or more of:
a date associated with each of the ranked list of items,
an assignee, wherein the assignee comprises one of an individual, an entity, and a group associated with each of the ranked list of items a component assigned in an issue tracking platform,
an error code,
an error message,
a ticket priority designation,
a project name, a customer name,
a ticket status,
a date associated with any item updates,
filetype,
type of items,
product category, and
a manually-added item; and
the one or more hardware processors are further configured by machine-readable instructions to:
filter the ranked list of items using one or more of the metadata associated with the one or more databases and the one or more websites.

8. A method of searching one or more data sources, the method comprising:
identifying one or more search terms;
identifying a context associated with the one or more search terms;
determining whether additional terms are associated with the one more search terms and the context associated with the one or more search terms;
accessing one more databases;
accessing information related to one or more web sites; and
providing a ranked list of items obtained from at least one of the one or more databases and the one or more web sites, wherein the ranked listed comprises items related to the one or more search terms.

9. The method of claim 8, wherein,
prior to identifying one or more search terms, the method further comprises:
implementing a taxonomy for the one or more search terms, wherein the taxonomy comprises associating one or more words with at least one of the one or more search terms;
the one or more databases comprise,
a ticketing system database involving one or more topics,
a database comprising client information,
an internal resource database, and
a general database, and
accessing information related to one or more web sites comprises,
crawling the website;
finding information related to at least one of the one or more topics and the one or more search terms; and
at least one of indexing and pointing to the information related to the at least one of the one or more topics and the one or more search terms.

10. The method of claim 9, wherein,
the ticketing system database comprises,
a first Jira cloud database, and
first information related to a customer;
the database comprising client information comprises,
a second Jira cloud database, and
second information related to a customer, wherein the second information related to a customer is different from the first information related to a customer;
the internal resource database comprises information related to,
individuals associated with an entity,
availability of the individuals, and
one or more subject matters associated with the individuals;
the general database comprises,
descriptions of at least some of the one or more topics, wherein at least some of the descriptions comprise a guides and books,
customer information,
process information, and
employee information;
the one or more web sites comprise one or more of,
a web and application management website,
a network monitoring website,
a database software website, and
an enterprise software website;
the one or more search terms comprise natural language search terms; and
identifying a context associated with the one or more search terms comprises for at least one of the one or more search terms applying another of the one or more search terms to identify a meaning of the at least one of the one or more search terms.

11. The method of claim 10, wherein,
the first information related to a customer comprises one or more of a problem and a question associated with one or more of a system associated with a customer and a third-party system; and
the one or more topics comprises,
an enterprise software system,
tax information, and
one of governmental compliance information and regulatory information.

12. The method of claim 10, wherein, using the another of the one or more search terms to identify a meaning of the at least one of the one or more search terms comprises:
accessing a data store;
finding in the data store one or more prior definitions of the at least one of the one or more search terms when used with the (1) another of the one or more search terms, and (2) any additional terms associated with the another of the one or more search terms; and
using the another of the one or more search terms to identify a meaning of the at least one of the one or more search terms comprises using the another of the one or more search terms, the one or more prior definitions, and the at least one of the one or more search terms to obtain a definition of the at least one of the one or more search terms.

13. The method of claim 8, wherein,
accessing one more databases and accessing information related to one or more web sites comprises (1) selecting one of the one more databases and the one or more web sites to access, and (2) reading data and metadata associated with the one or more databases and the one or more web sites;
the ranked list of items comprises a display of items;
one of a top item and a first item in the display of items comprises an item most likely to relate to the one or more search terms; and
one or a bottom item and a last item in the display of items comprises at item least likely to relate to the one or more search terms.

14. The method of claim 13, wherein the metadata comprises one or more of,
a date associated with each of the ranked list of items,
an assignee, wherein the assignee comprises one of an individual, an entity, and a group associated with each of the ranked list of items,
a component assigned in an issue tracking platform,
an error code,
an error message,
a ticket priority designation,
a project name,
a customer name,
a ticket status,
a date associated with any item updates,
filetype,
type of items,
product category, and
a manually-added item; and
the method further comprising:
filtering the ranked list of items using one or more of the metadata associated with the one or more databases and the one or more websites.

15. The method of claim 8, further comprising,
one of,
selecting one of the ranked list of items, wherein upon selecting the ranked list of items, the method further comprises accessing the selected item, and
previewing one of the ranked list of items, wherein upon previewing one of the ranked list of items, the method further comprises displaying at least a portion of the previewed item;
customizing the one more databases and the information related to one or more web sites to enable,
displaying the ranked list of items, and
the previewing one of the ranked list of items;
saving the ranked list of items;
accessing the saved ranked list of items;
sorting the ranked list of items by one sorting list category comprising,
relevance,
date,
size,
age group,
author,
category,
city,
company,
content type,
country,
department,
extension,
job title,
language,
path,
postal code,
presentation format,
region,
status, and
tag;
creating a sub-search tag, wherein the sub search tag comprises a tag associated with one or more of,
a sorting list category, and
a selected metadata item; and
applying the sub-search tag to one or more new search terms.

16. The method of claim 8, further comprising,
identifying a user providing the one or more search terms;
associating a plurality of permissions with the user; and
determining one or more portions of the one more databases and the one or more web sites accessible with by the user with the plurality of permissions.

17. The method of claim 16, wherein the plurality of permissions comprise,
issue tracking platform permissions;
collaborative document management and storage system permissions; and
project management software permissions.

18. The method of claim 8, wherein the ranked list of items is sorted by one or more of,
items selected from prior performed searches;
order of items selected from prior performed searches;
one or more or an up vote and a down vote; and
type of user.

19. The method of claim 18, wherein the order of items selected from prior performed searches comprises,
identifying a first selected item as a highly-ranked item; and
identifying a final selected item as a highest ranked item.

20. A non-transient computer-readable storage medium having instructions embodied thereon, the instructions being executable by one or more processors to perform a method for searching one or more data sources, the method comprising:
identifying one or more search terms;
identifying a context associated with the one or more search terms;
determining whether additional terms are associated with the one more search terms and the context associated with the one or more search terms;
accessing one more databases;
accessing information related to one or more web sites; and
providing a ranked list of items obtained from at least one of the one or more databases and the one or more web sites, wherein the ranked listed comprises items related to the one or more search terms.
